(19) United States
(12) Patent Application Publication
(10) Pub. No.: US 2024/0269703 A1
(43) Pub. Date: Aug. 15, 2024

(54) AUTOMATIC PAINT SPRAYING DEVICE FOR AUTOMOBILE PAINTING

(71) Applicant: Zhejiang Yueteng Information Technology Co., Ltd., Taizhou (CN)

(72) Inventors: Tengjie Tao, Taizhou (CN); Yingcheng Jiang, Taizhou (CN)

(21) Appl. No.: 18/469,076

(22) Filed: Sep. 18, 2023

(30) Foreign Application Priority Data
Feb. 14, 2023 (CN) 2023101069554

(51) Int. Cl. B05B 13/02; B05B 12/36

(52) U.S. Cl. CPC B05B 13/0242; B05B 12/36

(57) ABSTRACT

An automatic paint spraying device for automobile painting comprises a positioning operation base, semi-annular spraying sleeve, contact-stop side blocking mechanism, wheel-back shielding assembly and airflow fog-guiding mechanism. The semi-annular spraying sleeve is rotatably provided on the sidewall of the positioning operation base; the contact-stop side blocking mechanism is slidably clamped on the inner wall of the semi-annular spraying sleeve in an arc shape; the wheel-back shielding assembly is provided on the edge of the end side wall of the semi-annular spraying sleeve; and the airflow fog-guiding mechanism is fixedly penetrating through the sidewall of the semi-annular spraying sleeve. The invention combines physical blocking, negative pressure drainage and electrode effect, which improves wrapping efficiency through the semi-annular wrapping method, allows smooth entry of brake caliper through the bidirectional resistance rotation structure, and achieves automatic stop through rotation effect, significantly improving painting efficiency and reducing painting mist diffusion.

### 1. TECHNICAL FIELD

The invention belongs to the technical field of automobile spray painting, in particular to an automatic paint spraying device for automobile painting.

### 2. BACKGROUND ART

The automobile brake caliper is a clamping device attached to the side wall of the brake disc, having functions such as decelerating, stopping or keeping the stopped state of the wheels. To improve the aesthetic appearance of vehicles, many car owners choose to paint the brake calipers for modification with a youthful and personalized style.

In the prior art, spraying paint on the entire automobile brake caliper requires disassembling the brake caliper, which is very complicated and time-consuming with intensive labor. Spraying paint without disassembling requires purely manual operation. It is necessary to cover the surroundings of the brake caliper to prevent paint from spraying onto other parts of the vehicle, and to spray paint on the brake caliper multiple times. The painting process is very complex, and it is easy to affect the paint quality due to uneven coating, and easy to spray paint onto other areas of the vehicle due to gaps in the covering material. At the same time, the spray generated by manual spraying will have huge impacts on the health of the operator.

The prior art lacks a device that can efficiently paint automobile brake calipers without disassembling them, and effectively prevent painting mist from diffusion and contaminating the vehicle or affecting the health of the operator.

### 3. SUMMARY OF THE INVENTION

The invention overcomes the deficiencies in the prior art and provides an automatic paint spraying device for automobile painting. The device combines physical blocking, negative pressure drainage and electrode effect for painting automobile brake calipers. The semi-annular structure design and coaxial rotating wrapping method enable the device to adaptively match the special connecting structure between the automobile brake disc and brake caliper. The bidirectional resistance rotation structure allows the automobile brake caliper to smoothly enter the device. Furthermore, the rotation effect generated by the resistance of the automobile brake caliper is utilized to achieve a short circuit, thus realizing automatic stoppage. The invention significantly improves the device's efficiency in wrapping the automobile brake caliper, speeds up the coating efficiency, and significantly reduces the probability of painting mist adhering to the inner wall of the semi-annular spraying sleeve. The invention has the following technical solution:

the invention provides an automatic paint spraying device for automobile painting, comprising a positioning operation base, a semi-annular spraying sleeve, a contact-stop side blocking mechanism, a wheel-back shielding assembly and an airflow fog-guiding mechanism. The semi-annular spraying sleeve is rotatably provided on the side wall of the positioning operation base; a contact-stop side blocking mechanism is slidably and detachably attached on the inner wall of the semi-annular spraying sleeve in an arc shape; a wheel-back shielding assembly is provided on the edge of the end side wall of the semi-annular spraying sleeve; an airflow fog-guiding mechanism is fixedly penetrating through the side wall of the semi-annular spraying sleeve; the semi-annular spraying sleeve comprises a power sleeve, a semi-annular inner sleeve, a semi-circular baffle and a semi-annular outer sleeve; the power sleeve is clamped and rotatably provided on the side wall of the positioning operation base; the semi-annular inner sleeve is fixedly provided on the end side wall of the power sleeve away from the positioning operation base; the semi-circular baffle is fixedly provided on the peripheral edge of the outer wall of the power sleeve; the semi-annular outer sleeve is fixedly provided on the outer edge of the side wall of the semi-circular baffle away from the power sleeve; the semi-annular inner sleeve, the semicircular baffle and the semi-annular outer sleeve cover the same angular area relative to the axis of the power sleeve; the wheel-back shielding assembly is provided on the edge of the side wall of the semi-annular outer sleeve.

Preferably, an isolating semi-annular blade is fixedly provided on the edge of the side wall of the semi-annular inner sleeve away from the power sleeve; a positive electrode contact plate is fixedly provided in the middle of the edge of the side wall of the semi-annular outer sleeve away from the power sleeve; an abutting electric push rod is fixedly provided on the side wall of the positive electrode contact plate away from the power sleeve; an abutting rod is slidably provided through the side wall of the positive electrode contact plate; the end of the abutting rod away from the power sleeve is fixedly connected to the output end of the abutting electric push rod in an aligned manner; a first end baffle and a second end baffle are fixedly provided on the annular edge of the inner wall of the semi-annular outer sleeve; the first end baffle and the semi-annular inner sleeve are fixedly connected with each other at their adjacent edges; the second end baffle is fixedly connected with the first end baffle at their side edges away from the semicircular baffle; a first flexible shielding pad is fixedly provided on one side edge of the second end baffle close to the semi-annular inner sleeve; a power gear ring is coaxially provided on the outer wall of the power sleeve.

As a preferred embodiment of the solution, arc-shaped spraying guide rails are fixedly provided in parallel on the annular inner wall of the semi-annular outer sleeve; a spraying slider is slidably and detachably attached on the annular inner wall of the semi-annular outer sleeve in an arc shape; the spraying slider is slidably and detachably attached on the arc-shaped spraying guide rails in an arc shape; an arc-shaped spraying rack is fixedly provided on the annular inner wall of the semi-annular outer sleeve; the arc-shaped spraying rack is provided at the middle of the arc-shaped spraying guide rails; a spraying bent pipe is fixedly provided on the side wall of the spraying slider; nozzles are arranged in an array and penetrate through the outer wall of the spraying bent pipe; a spraying travel motor is fixedly provided on the inner wall of the spraying slider; a spraying travel gear is coaxially fixed at the output end of the spraying travel motor; the spraying travel gear is engaged with the arc-shaped spraying rack.

As a preferred embodiment of the solution, the contact-stop side blocking mechanism comprises a side blocking slider, a side blocking motor and a side blocking plate; the side blocking slider is slidably and detachably attached on the annular inner wall of the semi-annular outer sleeve in an arc shape through the arc-shaped spraying rack; the side blocking motor is fixedly provided on the side wall of the side blocking slider close to the arc-shaped spraying rack; the side blocking plate is rotatably provided on the side wall of the side blocking slider away from the side blocking motor; a side blocking power gear is fixedly connected to the output end of the side blocking motor in an aligned manner; the side blocking power gear is meshed with the arc-shaped spraying rack; a second flexible shielding pad is provided on the edge of the side blocking plate away from the side blocking slider.

Further, connecting rods are respectively fixedly provided on both side edges of the side blocking plate; the ends of the connecting rods away from the side blocking plate are rotatably connected to the side walls at both ends of the side blocking slider respectively; one of the connecting rods has a curved contact rod fixedly provided at the end away from the side blocking plate; a contact circuit breaker is slidably provided on the side wall of the side blocking slider close to the curved contact rod; the contact circuit breaker is located on one side of the outer arc surface of the curved contact rod; the contact circuit breaker is located within the movement path of the curved contact rod; a curved short-circuit contact piece is fixedly provided on the side wall of the curved contact rod close to the contact circuit breaker; a contact reset spring is fixedly provided at the end of the curved contact rod away from the connecting rod; the end of the contact reset spring away from the curved contact rod is fixedly connected to the side wall of the side blocking slider; a circuit breaker reset spring is fixedly provided on the side wall of the contact circuit breaker away from the curved contact rod; the end of the circuit breaker reset spring away from the contact circuit breaker is fixedly connected to the side wall of the side blocking slider; the curved short-circuit contact piece and the contact circuit breaker are electrically connected to the side blocking motor respectively. After the curved short-circuit contact piece and the contact circuit breaker are in contact, the side blocking motor is short-circuited.

Further, the airflow fog-guiding mechanism comprises an airflow pipe, an air pump and a filter box; the airflow pipe, the air pump and the filter box are respectively fixedly provided on the side wall of the semicircular baffle close to the power sleeve; one end of the airflow pipe is fixedly penetrating through and connected to the side wall of the filter box; the other end of the airflow pipe penetrates through the side wall of the semicircular baffle away from the power sleeve; the input end of the air pump is penetrated through and connected to the filter box. The airflow fog-guiding mechanism makes the inside of the semi-annular spraying sleeve in a slight negative pressure state, thereby effectively preventing painting mist from diffusing outward.

Preferably, the wheel-back shielding assembly comprises arc-shaped shielding bars and arc-shaped rubber baffles; the arc-shaped shielding bars are symmetrically and fixedly provided on the edge of the side wall of the semi-annular outer sleeve away from the semicircular baffle; the arc-shaped rubber baffles are arranged in an array and fixedly provided along the arc direction of the arc-shaped shielding bars on the side wall of the arc-shaped shielding bars.

Preferably, a cathode sheet is fixedly provided on the side wall of the positioning operation base; the end of the cathode sheet is elastically slidably attached to the outer wall of the power sleeve; a paint can is fixedly provided on the side wall of the positioning operation base; a paint pump is fixedly penetrating through the top wall of the paint can; the paint pump is penetrated through and connected to the spraying bent pipe via a hose. The abutting rod and cathode sheet are electrically connected. The abutting rod is the positive electrode, and the cathode sheet is the negative electrode. During operation, when the abutting rod abuts against the outer wall of the back of the automobile brake caliper, the automobile brake caliper carries a positive charge, and the cathode sheet causes the semi-annular spraying sleeve and paint to carry a negative charge.

Further, a positioning clamping motor is fixedly provided on the side wall of the positioning operation base close to the semi-annular spraying sleeve; a clamping gear is fixedly connected to the output end of the positioning clamping motor in an aligned manner; the clamping gear is meshed with the power gear ring. A control panel is fixedly provided on the top wall of the positioning operation base. The control panel is provided with a clamping bidirectional switch, a coupling bidirectional switch and a spraying switch. The clamping bidirectional switch is electrically connected to the positioning clamping motor. The coupling bidirectional switch is electrically connected to the side blocking motor. The spraying switch is electrically connected to the paint pump, spraying travel motor and air pump.

Further, a first latex coupling block is fixedly provided on the side wall of the second end baffle close to the positive electrode contact plate; a second latex coupling block is fixedly provided on the side wall of the side blocking plate close to the positive electrode contact plate.

The invention has the following beneficial effects by adopting the above structure:

(1) The semi-annular spraying sleeve enables the device to adaptively match the special connecting structure between the automobile brake disc and brake caliper through the semi-annular structural design and coaxial rotating wrapping method. The structure not only facilitates wrapping the automobile brake caliper, but also enables efficient spraying on the automobile brake caliper, and significantly reduces the possibility of painting mist diffusion.

(2) The contact-stop side blocking mechanism allows the automobile brake caliper to smoothly enter the device through the bidirectional resistance rotation structure. Furthermore, the rotation effect generated by the resistance of the automobile brake caliper is utilized to achieve a short circuit, thus realizing automatic stoppage. The structure significantly improves the device's efficiency in wrapping the automobile brake caliper.

(3) The side blocking plate and the second end baffle utilize the first latex coupling block and the second latex coupling block to clamp and couple the two ends of the automobile brake caliper, and utilize the first flexible shielding pad and the second flexible shielding pad to block and seal the gaps at the two ends of the automobile brake caliper, effectively reducing the possibility of painting mist diffusion.

(4) The wheel-back shielding assembly uses simple arc-shaped rubber baffles to block the gaps at the back of the brake disc. When the device wraps the automobile brake caliper, it is not restricted by the arc-shaped rubber baffles. After wrapping is completed, the arc-shaped rubber baffles automatically reset and automatically block the annular gaps on the outer side of the back of the brake disc.

(5) The airflow fog-guiding mechanism makes the inside of the semi-annular spraying sleeve in a slight negative pressure state, thereby effectively preventing painting mist from diffusing outward.

(6) When the abutting rod abuts against the outer wall of the back of the automobile brake caliper, it causes the automobile brake caliper to carry a positive charge, and the cathode sheet causes the semi-annular spraying sleeve and paint to carry a negative charge, which significantly improves the coating efficiency and significantly reduces the probability of painting mist adhering to the inner wall of the semi-annular spraying sleeve.

(7) The device sprays paint on the automobile brake caliper by combining physical blocking, negative pressure diversion and electrode effect, which significantly improves the painting efficiency and significantly reduces the possibility of painting mist diffusing outward.

### 4. BRIEF DESCRIPTION OF ACCOMPANY DRAWINGS

FIG. 1 is a schematic diagram I showing the structure of an automatic paint spraying device for automobile painting proposed by the invention;

FIG. 2 is a schematic diagram II showing the structure of an automatic paint spraying device for automobile painting proposed by the invention;

FIG. 3 is a schematic diagram I showing the structure of the semi-annular spraying sleeve proposed by the invention;

FIG. 4 is a schematic diagram II showing the structure of the semi-annular spraying sleeve proposed by the invention;

FIG. 5 is a schematic diagram showing the structure of the positive electrode contact plate proposed by the invention;

FIG. 6 is a schematic diagram showing the structure of the spraying slider proposed by the invention;

FIG. 7 is a schematic diagram showing the structure of the contact-stop side blocking mechanism proposed by the invention;

FIG. 8 is an enlarged partial view of portion A in FIG. 7;

FIG. 9 is a side view of the contact-stop side blocking mechanism proposed by the invention;

FIG. 10 is a schematic diagram showing the operation of the invention wrapping and spraying the automobile brake disc caliper.

In the figures: 1. positioning operation base; 11. cathode sheet; 12. paint can; 121. paint pump; 13. positioning clamping motor; 131. clamping gear; 14. control panel; 141. clamping bidirectional switch; 142. coupling bidirectional switch; 143. spraying switch; 2. semi-annular spraying sleeve; 21. power sleeve; 211. power gear ring; 22. semi-annular inner sleeve; 221. isolating semi-annular blade; 23. semicircular baffle; 24. semi-annular outer sleeve; 241. positive electrode contact plate; 2411. abutting electric push rod; 2412. abutting rod; 242. first end baffle; 243. second end baffle; 2431. first flexible shielding pad; 2432. first latex coupling block; 244. arc-shaped spraying guide rail; 245. spraying slider; 2451. spraying bent pipe; 2452. nozzle; 2453. spraying travel motor; 2454. spraying travel gear; 246. arc-shaped spraying rack; 3. contact-stop side blocking mechanism; 31. side blocking slider; 311. contact circuit breaker; 3111. circuit breaker reset spring; 32. side blocking motor; 321. side blocking power gear; 33. side blocking plate; 331. second flexible shielding pad; 332. connecting rod; 3321. curved contact rod; 3322. curved short-circuit contact piece; 3323. contact reset spring; 333. second latex coupling block; 4. wheel-back shielding assembly; 41. arc-shaped shielding bar; 42. arc-shaped rubber baffle; 5. airflow fog-guiding mechanism; 51. airflow pipe; 52. air pump; 53. filter box.

The drawings are provided to further illustrate the present invention and constitute a part of the specification. The embodiments of the invention and the drawings together serve to explain the principles of the present invention and shall not be construed to limit the invention.

### 5. SPECIFIC EMBODIMENT OF THE INVENTION

To make the technical solutions provided by the invention more comprehensible, a further description of the invention is given below in combination with the attached drawings and embodiments, and the embodiments are exemplary and not the limitations of the scope of the disclosure. Apparently, the described drawings are merely some embodiments of the application rather than all the embodiments of the application. It should be understood that the application is not limited to the drawings described herein. Based on the drawings in the invention, all other drawings obtained by those of ordinary skill in the art without making creative labor fall within the scope of protection of the invention.

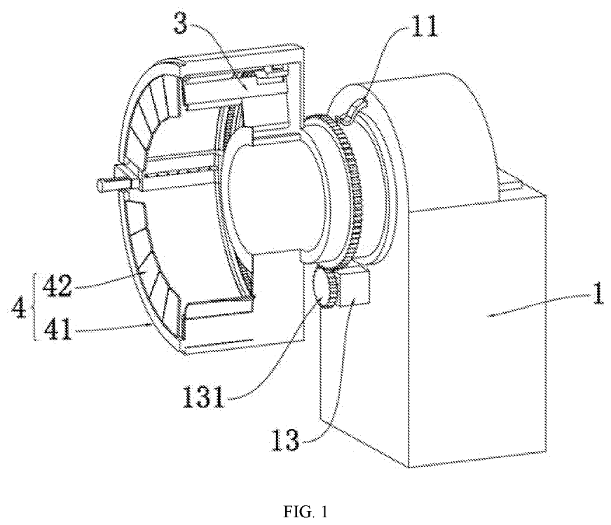

Referring to the FIG. 1 to FIG. 3, the embodiment provides an automatic paint spraying device for automobile painting comprising a positioning operation base 1, a semi-annular spraying sleeve 2, a contact-stop side blocking mechanism 3, a wheel-back shielding assembly 4 and an airflow fog-guiding mechanism 5. The semi-annular spraying sleeve 2 is rotatably provided on the side wall of the positioning operation base 1; a contact-stop side blocking mechanism 3 is slidably and detachably attached on the inner wall of the semi-annular spraying sleeve 2 in an arc shape; a wheel-back shielding assembly 4 is provided on the edge of the end side wall of the semi-annular spraying sleeve 2; an airflow fog-guiding mechanism 5 is fixedly penetrating through the side wall of the semi-annular spraying sleeve 2; the semi-annular spraying sleeve 2 comprises a power sleeve 21, a semi-annular inner sleeve 22, a semi-circular baffle 23 and a semi-annular outer sleeve 24; the power sleeve 21 is clamped and rotatably provided on the side wall of the positioning operation base 1; the semi-annular inner sleeve 22 is fixedly provided on the end side wall of the power sleeve 21 away from the positioning operation base 1; the semi-circular baffle 23 is fixedly provided on the peripheral edge of the outer wall of the power sleeve 21; the semi-annular outer sleeve 24 is fixedly provided on the outer edge of the side wall of the semi-circular baffle 23 away from the power sleeve 21; the semi-annular inner sleeve 22, the semicircular baffle 23 and the semi-annular outer sleeve 24 cover the same angular area relative to the axis of the power sleeve 21; the wheel-back shielding assembly 4 is provided on the edge of the side wall of the semi-annular outer sleeve 24.

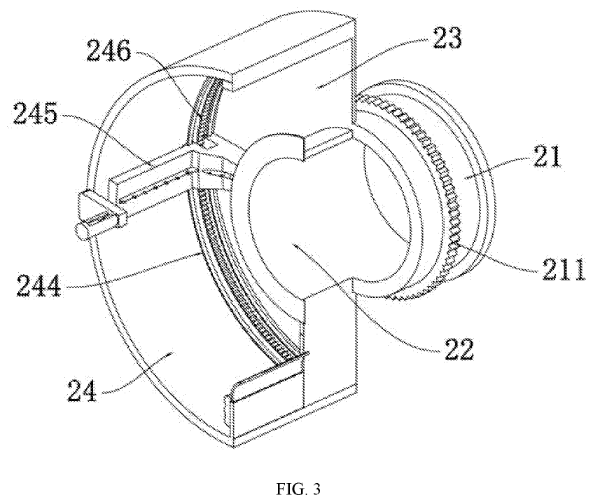

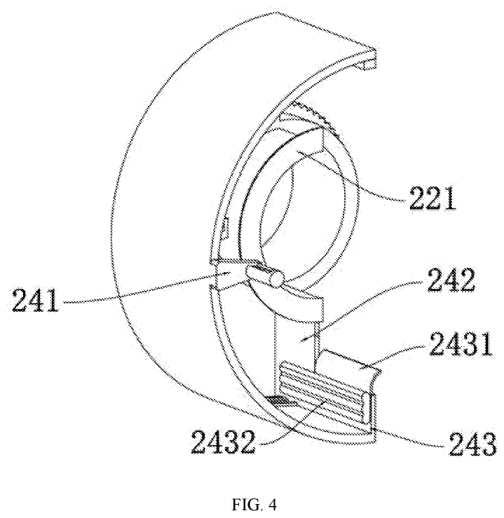

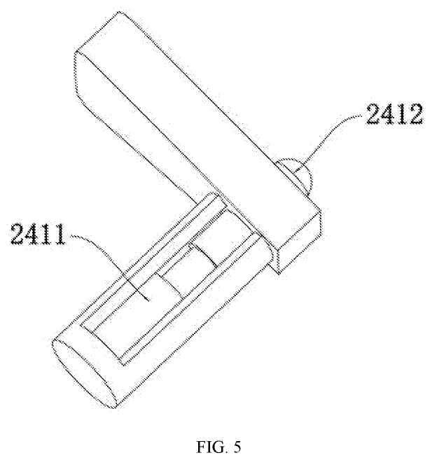

Referring to the FIG. 3 to FIG. 5, an isolating semi-annular blade 221 is fixedly provided on the edge of the side wall of the semi-annular inner sleeve 22 away from the power sleeve 21; a positive electrode contact plate 241 is fixedly provided in the middle of the edge of the side wall of the semi-annular outer sleeve 24 away from the power sleeve 21; an abutting electric push rod 2411 is fixedly provided on the side wall of the positive electrode contact plate 241 away from the power sleeve 21; an abutting rod 2412 is slidably provided through the side wall of the positive electrode contact plate 241; the end of the abutting rod 2412 away from the power sleeve 21 is fixedly connected to the output end of the abutting electric push rod 2411 in an aligned manner; a first end baffle 242 and a second end baffle 243 are fixedly provided on the annular edge of the inner wall of the semi-annular outer sleeve 24; the first end baffle 242 and the semi-annular inner sleeve 22 are fixedly connected with each other at their adjacent edges; the second end baffle 243 is fixedly connected with the first end baffle 242 at their side edges away from the semicircular baffle 23; a first flexible shielding pad 2431 is fixedly provided on one side edge of the second end baffle 243 close to the semi-annular inner sleeve 22; a power gear ring 211 is coaxially provided on the outer wall of the power sleeve 21.

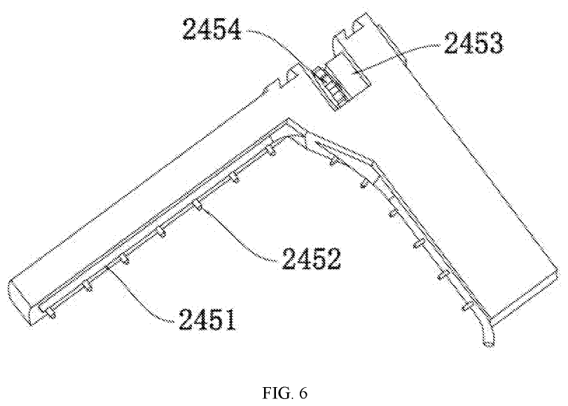

Referring to the FIG. 3 to FIG. 6, arc-shaped spraying guide rails 244 are fixedly provided in parallel on the annular inner wall of the semi-annular outer sleeve 24; a spraying slider 245 is slidably and detachably attached on the annular inner wall of the semi-annular outer sleeve 24 in an arc shape; the spraying slider 245 is slidably and detachably attached on the arc-shaped spraying guide rails 244 in an arc shape; an arc-shaped spraying rack 246 is fixedly provided on the annular inner wall of the semi-annular outer sleeve 24; the arc-shaped spraying rack 246 is provided at the middle of the arc-shaped spraying guide rails 244; a spraying bent pipe 2451 is fixedly provided on the side wall of the spraying slider 245; nozzles 2452 are arranged in an array and penetrate through the outer wall of the spraying bent pipe 2451; a spraying travel motor 2453 is fixedly provided on the inner wall of the spraying slider 245; a spraying travel gear 2454 is coaxially fixed at the output end of the spraying travel motor 2453; the spraying travel gear 2454 is engaged with the arc-shaped spraying rack 246.

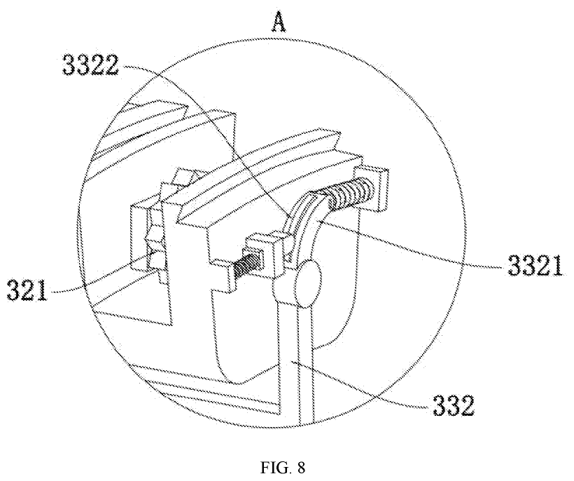

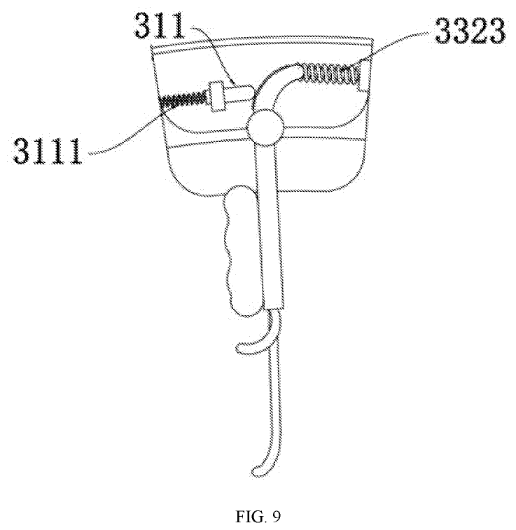

Referring to the FIG. 1 and FIG. 7 to FIG. 9, the contact-stop side blocking mechanism 3 comprises a side blocking slider 31, a side blocking motor 32 and a side blocking plate 33; the side blocking slider 31 is slidably and detachably attached on the annular inner wall of the semi-annular outer sleeve 24 in an arc shape through the arc-shaped spraying rack 246; the side blocking motor 32 is fixedly provided on the side wall of the side blocking slider 31 close to the arc-shaped spraying rack 246; the side blocking plate 33 is rotatably provided on the side wall of the side blocking slider away from the side blocking motor 32; a side blocking power gear 321 is fixedly connected to the output end of the side blocking motor 32 in an aligned manner; the side blocking power gear 321 is meshed with the arc-shaped spraying rack 246; a second flexible shielding pad 331 is provided on the edge of the side blocking plate 33 away from the side blocking slider 31.

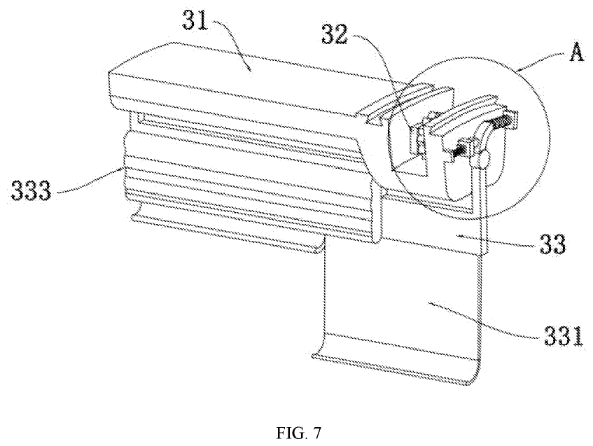

Referring to the FIG. 7 to FIG. 9, connecting rods 332 are respectively fixedly provided on both side edges of the side blocking plate 33; the ends of the connecting rods 332 away from the side blocking plate 33 are rotatably connected to the side walls at both ends of the side blocking slider 31 respectively; one of the connecting rods 332 has a curved contact rod 3321 fixedly provided at the end away from the side blocking plate 33; a contact circuit breaker 311 is slidably provided on the side wall of the side blocking slider 31 close to the curved contact rod 3321; the contact circuit breaker 311 is located on one side of the outer arc surface of the curved contact rod 3321; the contact circuit breaker 311 is located within the movement path of the curved contact rod 3321; a curved short-circuit contact piece 3322 is fixedly provided on the side wall of the curved contact rod 3321 close to the contact circuit breaker 311; a contact reset spring 3323 is fixedly provided at the end of the curved contact rod 3321 away from the connecting rod 332; the end of the contact reset spring 3323 away from the curved contact rod 3321 is fixedly connected to the side wall of the side blocking slider 31; a circuit breaker reset spring 3111 is fixedly provided on the side wall of the contact circuit breaker 311 away from the curved contact rod 3321; the end of the circuit breaker reset spring 3111 away from the contact circuit breaker 311 is fixedly connected to the side wall of the side blocking slider 31; the curved short-circuit contact piece 3322 and the contact circuit breaker 311 are electrically connected to the side blocking motor 32 respectively. After the curved short-circuit contact piece 3322 and the contact circuit breaker 311 are in contact, the side blocking motor 32 is short-circuited.

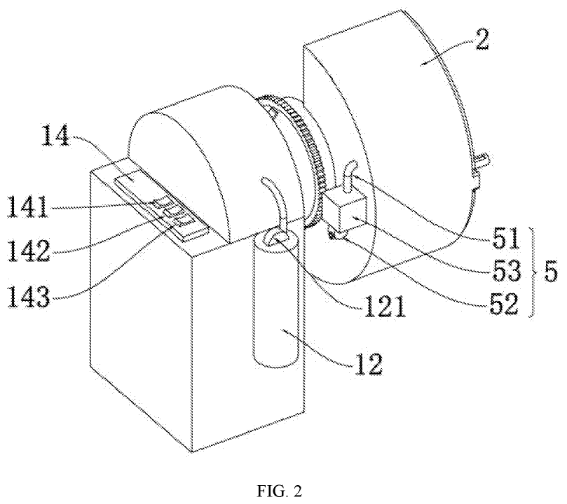

Referring to the FIG. 2 and FIG. 3, the airflow fog-guiding mechanism 5 comprises an airflow pipe 51, an air pump 52 and a filter box 53; the airflow pipe 51, the air pump 52 and the filter box 53 are respectively fixedly provided on the side wall of the semicircular baffle 23 close to the power sleeve 21; one end of the airflow pipe 51 is fixedly penetrating through and connected to the side wall of the filter box 53; the other end of the airflow pipe 51 penetrates through the side wall of the semicircular baffle 23 away from the power sleeve 21; the input end of the air pump 52 is penetrated through and connected to the filter box 53..

Referring to the FIG. 1 and FIG. 3, the wheel-back shielding assembly 4 comprises arc-shaped shielding bars 41 and arc-shaped rubber baffles 42; the arc-shaped shielding bars 41 are symmetrically and fixedly provided on the edge of the side wall of the semi-annular outer sleeve 24 away from the semicircular baffle 23; the arc-shaped rubber baffles 42 are arranged in an array and fixedly provided along the arc direction of the arc-shaped shielding bars 41 on the side wall of the arc-shaped shielding bars 41.

Referring to the FIG. 1 to FIG. 6, a cathode sheet 11 is fixedly provided on the side wall of the positioning operation base 1; the end of the cathode sheet 11 is elastically slidably attached to the outer wall of the power sleeve 21; a paint can 12 is fixedly provided on the side wall of the positioning operation base 1; a paint pump 121 is fixedly penetrating through the top wall of the paint can 12; the paint pump 121 is penetrated through and connected to the spraying bent pipe 2451 via a hose.

Referring to the FIG. 1 and FIG. 2, a positioning clamping motor 13 is fixedly provided on the side wall of the positioning operation base 1 close to the semi-annular spraying sleeve 2; a clamping gear 131 is fixedly connected to the output end of the positioning clamping motor 13 in an aligned manner; the clamping gear 131 is meshed with the power gear ring 211. A control panel 14 is fixedly provided on the top wall of the positioning operation base 1. The control panel 14 is provided with a clamping bidirectional switch 141, a coupling bidirectional switch 142 and a spraying switch 143. The clamping bidirectional switch 141 is electrically connected to the positioning clamping motor 13. The coupling bidirectional switch 142 is electrically connected to the side blocking motor 32. The spraying switch 143 is electrically connected to the paint pump 121, air pump 52 and spraying travel motor 2453.

Referring to the FIG. 1, a first latex coupling block 2432 is fixedly provided on the side wall of the second end baffle 243 close to the positive electrode contact plate 241; a second latex coupling block 333 is fixedly provided on the side wall of the side blocking plate 33 close to the positive electrode contact plate 241.

In specific use of the embodiment, the semi-annular spraying sleeve 2 rotates to wrap the brake disc and automobile brake caliper, and utilizes the arc motion of the contact-stop side blocking mechanism 3 to clamp and couple the two ends of the automobile brake caliper. The wheel-back shielding assembly 4 blocks the space at the back of the brake disc. The airflow fog-guiding mechanism 5 sucks the painting mist inside the semi-annular spraying sleeve 2 and makes the interior of the semi-annular spraying sleeve 2 at a lower air pressure level, thereby preventing the painting mist from diffusing outward.

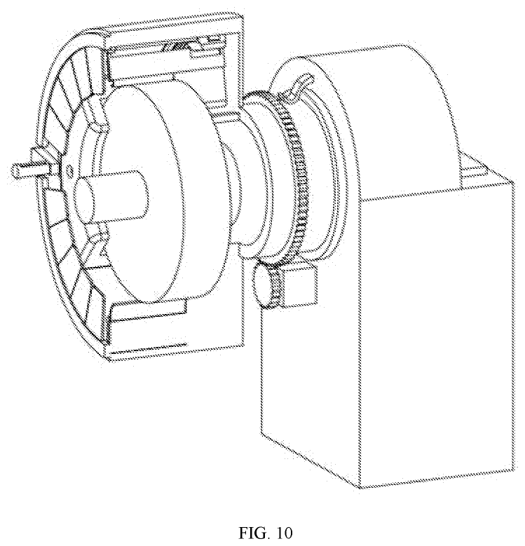

After the operator removes the automobile tire, the exposed oil passages, nuts and other parts on the middle section of the automobile brake caliper are wrapped with protective films. After adjusting the height, the paint spraying device provided in this solution is placed at the side of the brake disc, with the power sleeve 21 coaxial with the brake disc. In the initial state, the relative position between the semi-annular outer sleeve 24 and the axis of the brake disc is opposite to that of the automobile brake caliper, thereby smoothly entering the brake disc area. The semi-annular inner sleeve 22 side wall abuts against the side wall of the brake disc. At this time, the isolating semi-annular blade 221 attaches to the side wall of the brake disc, and the semi-annular outer sleeve 24 is located outside the circumference of the brake disc, but in the position opposite to the automobile brake caliper. The operator presses the clamping bidirectional switch 141, the positioning clamping motor 13 runs, driving the clamping gear 131 and the power gear ring 211 to rotate, so that the entire semi-annular spraying sleeve 2 rotates around the axis of the brake disc. The edge of the isolating semi-annular blade 221 first engages into the gap between the side wall of the brake disc and the inner side wall of the automobile brake caliper. Then, the contact-stop side blocking mechanism 3 starts to contact the end of the automobile brake caliper. The side blocking plate 33 rotates due to the resistance of the automobile brake caliper, and the curved contact rod 3321 rotates synchronously away from the contact circuit breaker 311. After the automobile brake caliper completely enters the inner area of the semi-annular outer sleeve 24, the side blocking plate 33 restores its initial state under the elastic force of the contact reset spring 3323 and surrounds one end of the automobile brake caliper, reducing the passage for painting mist to diffuse. The semi-annular spraying sleeve 2 continues to rotate. At this time, the state of the device and the automobile brake disc is as shown in FIG. 10. When the first end baffle 242 and the second end baffle 243 abut against the ends of the automobile brake caliper, the positioning clamping motor 13 stops operating and the semi-annular spraying sleeve 2 stops rotating. The first latex coupling block 2432 couples with the end of the automobile brake caliper. The first flexible shielding pad 2431 seals the gap between the brake disc and the first flexible shielding pad 2431, reducing the possibility of painting mist diffusion. The operator presses the coupling bidirectional switch 142, the side blocking motor 32 runs, and drives the side blocking slider 31 to move along the annular inner wall of the semi-annular outer sleeve 24 towards the automobile brake caliper through the meshing action between the side blocking power gear 321 and the arc-shaped spraying rack 246. When the second latex coupling block 333 on one side of the side blocking plate 33 attaches to the other end of the automobile brake caliper, the side blocking plate 33 is blocked by the automobile brake caliper and rotates synchronously. The curved contact rod 3321 rotates synchronously and gets close to the contact circuit breaker 311. The contact circuit breaker 311 is pushed and pressed. After the curved short-circuit contact piece 3322 and the contact circuit breaker 311 contact each other, the side blocking motor 32 is short-circuited and the contact-stop side blocking mechanism 3 stops operating. The side blocking plate 33 and the second end baffle 243 jointly clamp both ends of the automobile brake caliper and seal the gaps at both ends of the automobile brake caliper, effectively reducing the possibility of painting mist diffusion. After the device is in place, the abutting electric push rod 2411 pushes the abutting rod 2412 to get close to and attach to the side wall of the automobile brake caliper, so that the automobile brake caliper is charged.

When starting spraying, the operator presses the spraying switch 143, and the spraying travel motor 2453 drives the spraying travel gear 2454 to rotate. Under the action of the arc-shaped spraying rack 246, the spraying slider 245 moves along the arc-shaped inner wall of the semi-annular outer sleeve 24. The paint pump 121 makes the color paint in the paint can 12 enter the spraying bent pipe 2451 and sprays out from the nozzle 2452 onto the outer wall of the automobile brake caliper. During the spraying process, the air pump 52 gradually discharges the gas in the interior space of the semi-annular spraying sleeve 2 through the airflow pipe 51 to the filter box 53, making the interior of the semi-annular spraying sleeve 2 in a slight negative pressure state, further reducing the possibility of painting mist diffusing outward. The abutting rod 2412 and the cathode sheet 11 make the charge carried by the automobile brake caliper electrically opposite to the charge carried by the semi-annular spraying sleeve 2 and the paint, thereby improving the coating efficiency and significantly reducing the probability of painting mist adhering to the inner wall of the semi-annular spraying sleeve 2. After spraying is completed, the device runs reversely and no longer wraps the automobile brake caliper after the paint solidifies.

In the description of the embodiments of the invention, it should be noted that relational terms such as ‘first’ and ‘second’ are used merely to distinguish one entity or action from another entity or action without necessarily requiring or implying any actual such relationship or order between them.

The invention and the embodiments thereof are described hereinabove, and this description is not restrictive. What is shown in the drawings is only one of the embodiments of the invention, and the actual structure is not limited thereto. In summary, structural methods and embodiments similar to the technical solution without departing from the inventive purpose of the invention made by inspired ordinary technicians in the art without creative efforts shall all fall within the protection scope of the invention.

1. An automatic paint spraying device for automobile painting, comprising a positioning operation base (1), wherein a semi-annular spraying sleeve (2) is rotatably provided on the side wall of the positioning operation base (1); a contact-stop side blocking mechanism (3) is slidably and detachably attached on the inner wall of the semi-annular spraying sleeve (2) in an arc shape; a wheel-back shielding assembly (4) is provided on the edge of the end side wall of the semi-annular spraying sleeve (2); an airflow fog-guiding mechanism (5) is fixedly penetrating through the side wall of the semi-annular spraying sleeve (2); the semi-annular spraying sleeve (2) comprises a power sleeve (21), a semi-annular inner sleeve (22), a semi-circular baffle (23) and a semi-annular outer sleeve (24); the power sleeve (21) is clamped and rotatably provided on the side wall of the positioning operation base (1); the semi-annular inner sleeve (22) is fixedly provided on the end side wall of the power sleeve (21) away from the positioning operation base (1); the semi-circular baffle (23) is fixedly provided on the peripheral edge of the outer wall of the power sleeve (21); the semi-annular outer sleeve (24) is fixedly provided on the outer edge of the side wall of the semi-circular baffle (23) away from the power sleeve (21); the semi-annular inner sleeve (22), the semicircular baffle (23) and the semi-annular outer sleeve (24) cover the same angular area relative to the axis of the power sleeve (21); the wheel-back shielding assembly (4) is provided on the edge of the side wall of the semi-annular outer sleeve (24).

2. An automatic paint spraying device for automobile painting as claimed in claim 1, wherein an isolating semi-annular blade (221) is fixedly provided on the edge of the side wall of the semi-annular inner sleeve (22) away from the power sleeve (21); a positive electrode contact plate (241) is fixedly provided in the middle of the edge of the side wall of the semi-annular outer sleeve (24) away from the power sleeve (21); an abutting electric push rod (2411) is fixedly provided on the side wall of the positive electrode contact plate (241) away from the power sleeve (21); an abutting rod (2412) is slidably provided through the side wall of the positive electrode contact plate (241); the end of the abutting rod (2412) away from the power sleeve (21) is fixedly connected to the output end of the abutting electric push rod (2411) in an aligned manner; a first end baffle (242) and a second end baffle (243) are fixedly provided on the annular edge of the inner wall of the semi-annular outer sleeve (24); the first end baffle (242) and the semi-annular inner sleeve (22) are fixedly connected with each other at their adjacent edges; the second end baffle (243) is fixedly connected with the first end baffle (242) at their side edges away from the semicircular baffle (23); a first flexible shielding pad (2431) is fixedly provided on one side edge of the second end baffle (243) close to the semi-annular inner sleeve (22); a power gear ring (211) is coaxially provided on the outer wall of the power sleeve (21).

3. An automatic paint spraying device for automobile painting as claimed in claim 2, wherein arc-shaped spraying guide rails (244) are fixedly provided in parallel on the annular inner wall of the semi-annular outer sleeve (24); a spraying slider (245) is slidably and detachably attached on the annular inner wall of the semi-annular outer sleeve (24) in an arc shape; the spraying slider (245) is slidably and detachably attached on the arc-shaped spraying guide rails (244) in an arc shape; an arc-shaped spraying rack (246) is fixedly provided on the annular inner wall of the semi-annular outer sleeve (24); the arc-shaped spraying rack (246) is provided at the middle of the arc-shaped spraying guide rails (244); a spraying bent pipe (2451) is fixedly provided on the side wall of the spraying slider (245); nozzles (2452) are arranged in an array and penetrate through the outer wall of the spraying bent pipe (2451); a spraying travel motor (2453) is fixedly provided on the inner wall of the spraying slider (245); a spraying travel gear (2454) is coaxially fixed at the output end of the spraying travel motor (2453); the spraying travel gear (2454) is engaged with the arc-shaped spraying rack (246).

4. An automatic paint spraying device for automobile painting as claimed in claim 3, wherein the contact-stop side blocking mechanism (3) comprises a side blocking slider (31), a side blocking motor (32) and a side blocking plate (33); the side blocking slider (31) is slidably and detachably attached on the annular inner wall of the semi-annular outer sleeve (24) in an arc shape through the arc-shaped spraying rack (246); the side blocking motor (32) is fixedly provided on the side wall of the side blocking slider (31) close to the arc-shaped spraying rack (246); the side blocking plate (33) is rotatably provided on the side wall of the side blocking slider away from the side blocking motor (32); a side blocking power gear (321) is fixedly connected to the output end of the side blocking motor (32) in an aligned manner; the side blocking power gear (321) is meshed with the arc-shaped spraying rack (246); a second flexible shielding pad (331) is provided on the edge of the side blocking plate (33) away from the side blocking slider (31).

5. An automatic paint spraying device for automobile painting as claimed in claim 4, wherein connecting rods (332) are respectively fixedly provided on both side edges of the side blocking plate (33); the ends of the connecting rods (332) away from the side blocking plate (33) are rotatably connected to the side walls at both ends of the side blocking slider (31) respectively; one of the connecting rods (332) has a curved contact rod (3321) fixedly provided at the end away from the side blocking plate (33); a contact circuit breaker (311) is slidably provided on the side wall of the side blocking slider (31) close to the curved contact rod (3321); the contact circuit breaker (311) is located on one side of the outer arc surface of the curved contact rod (3321); the contact circuit breaker (311) is located within the movement path of the curved contact rod (3321); a curved short-circuit contact piece (3322) is fixedly provided on the side wall of the curved contact rod (3321) close to the contact circuit breaker (311); a contact reset spring (3323) is fixedly provided at the end of the curved contact rod (3321) away from the connecting rod (332); the end of the contact reset spring (3323) away from the curved contact rod (3321) is fixedly connected to the side wall of the side blocking slider (31); a circuit breaker reset spring (3111) is fixedly provided on the side wall of the contact circuit breaker (311) away from the curved contact rod (3321); the end of the circuit breaker reset spring (3111) away from the contact circuit breaker (311) is fixedly connected to the side wall of the side blocking slider (31); the curved short-circuit contact piece (3322) and the contact circuit breaker (311) are electrically connected to the side blocking motor (32) respectively.

6. An automatic paint spraying device for automobile painting as claimed in claim 5, wherein the airflow fog-guiding mechanism (5) comprises an airflow pipe (51), an air pump (52) and a filter box (53); the airflow pipe (51), the air pump (52) and the filter box (53) are respectively fixedly provided on the side wall of the semicircular baffle (23) close to the power sleeve (21); one end of the airflow pipe (51) is fixedly penetrating through and connected to the side wall of the filter box (53); the other end of the airflow pipe (51) penetrates through the side wall of the semicircular baffle (23) away from the power sleeve (21); the input end of the air pump (52) is penetrated through and connected to the filter box (53).

7. An automatic paint spraying device for automobile painting as claimed in claim 6, wherein the wheel-back shielding assembly (4) comprises arc-shaped shielding bars (41) and arc-shaped rubber baffles (42); the arc-shaped shielding bars (41) are symmetrically and fixedly provided on the edge of the side wall of the semi-annular outer sleeve (24) away from the semicircular baffle (23); the arc-shaped rubber baffles (42) are arranged in an array and fixedly provided along the arc direction of the arc-shaped shielding bars (41) on the side wall of the arc-shaped shielding bars (41).

8. An automatic paint spraying device for automobile painting as claimed in claim 7, wherein a cathode sheet (11) is fixedly provided on the side wall of the positioning operation base (1); the end of the cathode sheet (11) is elastically slidably attached to the outer wall of the power sleeve (21); a paint can (12) is fixedly provided on the side wall of the positioning operation base (1); a paint pump (121) is fixedly penetrating through the top wall of the paint can (12); the paint pump (121) is penetrated through and connected to the spraying bent pipe (2451) via a hose.

9. An automatic paint spraying device for automobile painting as claimed in claim 8, wherein a positioning clamping motor (13) is fixedly provided on the side wall of the positioning operation base (1) close to the semi-annular spraying sleeve (2); a clamping gear (131) is fixedly connected to the output end of the positioning clamping motor (13) in an aligned manner; the clamping gear (131) is meshed with the power gear ring (211).

10. An automatic paint spraying device for automobile painting as claimed in claim 9, wherein a first latex coupling block (2432) is fixedly provided on the side wall of the second end baffle (243) close to the positive electrode contact plate (241); a second latex coupling block (333) is fixedly provided on the side wall of the side blocking plate (33) close to the positive electrode contact plate (241).
